(19) United States
(12) Patent Application Publication
(10) Pub. No.: US 2008/0029059 A1
(43) Pub. Date: Feb. 7, 2008

(54) Rotary Internal Combustion Engine with a Circular Rotor

(76) Inventor: Arthur Isbrecht, Steinbach (CA)

Correspondence Address: ADE & COMPANY INC., 2157 Henderson Highway, WINNIPEG, MB, R2G1P9, US

(21) Appl. No.: 11/763,162

(22) Filed: Jun. 14, 2007

Related U.S. Application Data
(60) Provisional application No. 60/821,332, filed on Aug. 3, 2006.

(51) Int. Cl. F02B 53/04

(52) U.S. Cl. 123/203

(57) ABSTRACT

An internal combustion engine features a stator containing a rotor mounted on a driveshaft, the rotor and a hollow interior of the stator each being cylindrical in shape and circular in cross section. An air and fuel intake communicates with the stator interior and a spark plug provide sparks within combustion chambers, each formed by a cavity in the rotor and a respective seal disposed thereabout to seal with the stator. An exhaust outtake is spaced about the driveshaft from the air and fuel intake and the spark plug. Combustion of the fuel introduced to the cavities by the air and fuel intake after ignition by the spark plug drives rotation of the rotor and drive shaft in a predetermined direction to pass the cavity through fluid communication with the exhaust outtake and once again reach the air and fuel intake to repeat the rotation.

This application claims the benefit under 35 U.S.C. 119(e) of U.S. provisional application Ser. No. 60/821,332, filed Aug. 3, 2006.

### FIELD OF THE INVENTION

The present invention relates to internal combustion engines and more particularly to an internal combustion engine using rotational motion of one or more rotors, rather than linear displacement of pistons, to produce power.

### BACKGROUND

Modern internal combustion engines use a four stage cycle to obtain power for rotational motion from the ignition of a combustible fuel, such as gasoline. The first stage is intake wherein a mixture of air and fuel is introduced into a combustion chamber. The second stage is the compression of this mixture within the combustion chamber in preparation for the next stage, the power stage. In the power, or combustion stage, the compressed air and fuel mixture is ignited and the combustion rapidly increased the pressure within the combustion chamber. This pressure is exerted on a movable mechanical part, for example a linearly displaceable piston or a rotatable rotor, to harness power by capturing motion of this movable part. The final fourth stage is the exhausting of gases remaining in the combustion chamber.

Piston-based engines involve the reciprocation of one or more pistons within a respective cylinder. In many applications, the pistons are pivotally connected to a crankshaft to convert their linear motion into more useful rotational motion. A full rotation of the crankshaft corresponds to two complete strokes of a piston within its cylinder. In a four-stroke engine, a piston completes one combustion cycle for every two rotations of the crankshaft. A two-stroke engine is capable or producing more power as each piston completes its combustion cycle once every crankshaft rotation. However, two-stroke engines are generally less efficient and create more pollution.

Rotary combustion engines involve rotational motion of a rotor within a stator instead of reciprocating motion of a piston within a cylinder. Such engines may benefit from a higher power to weight ratio, lower mechanical complexity and vibration reduction when compared to reciprocating engines. A Wankel engine is a rotary combustion engine featuring a three-sided rotor arranged for planetary motion within an epitrochoid housing. The corners and faces of the rotor seal against the housing to divide its interior into three combustion chambers, each of which carries out four stages of the combustion cycle per rotor rotation for a total of twelve stages. However, the rotor rotates once for every three rotations of an output driveshaft, resulting in four completed stages of the combustion cycle per output rotation, the same as a two-stoke reciprocating engine piston and more than the four-stroke engine pistons typically used in automobiles. A quasiturbine engine (U.S. Pat. No. 6,164,263) is a rotary combustion engine featuring a four-sided rhomboid rotor with its sides hinged at the corners. Similar to the Wankel engine, the corners and faces of the rotor seal against an oval-like housing like, but four chambers are created instead of three due to the four-sided rotor. However, the rotor turns at the same rate as the output driveshaft and therefore carries out sixteen completed stages of the combustion cycle per output rotation. While each of these rotary engines may provide more power than a four-stroke reciprocal engine in a smaller package, each may be limited in the power increase it can provide due to the difference in shape between the rotor and housing necessary to change the size of the combustion chambers for compression during rotation of the rotor.

### SUMMARY

According to a first aspect of the invention there is provided an internal combustion engine comprising:

at least one rotary combustion unit comprising:
a stator defining a cylindrical interior of circular cross section;
a cylindrical rotor of circular cross section supported within the stator interior for rotation with a drive shaft extending through the stator along a central axis, the rotor having a plurality of cavities therein radially spaced from the drive shaft and angularly spaced thereabout;
each cavity in the rotor having a respective seal disposed thereabout extending outward from the rotor to the stator;
an air and fuel intake extending from an exterior of the stator to an interior thereof to feed fuel and air into the engine for combustion therein;
a spark plug supported on the stator to provide sparks within combustion chambers, each combustion chamber formed by enclosure of a respective one of the cavities in the rotor by the stator and the respective seal during a combustion stage of the rotor's rotation; and
an exhaust outtake extending from the interior of the stator to the exterior thereof to discharge exhaust gases from the engine after combustion, the exhaust outtake being circumferentially spaced about the central axis from the air and fuel intake and spark plug;

whereby combustion of the fuel introduced to the cavities by the air and fuel intake due to ignition in the combustion chamber by the spark plug drives rotation of the rotor and drive shaft in a predetermined direction to pass the cavity through fluid communication with the exhaust outtake and once again reach the air and fuel intake to repeat the rotation.

Due to the rotor and the stator interior both having a circular cross section, the size of the combustion chamber formed between the rotor and stator at each cavity does not change with rotation of the rotor. As a result, the engine of the present invention does not perform compression of the combustion chamber contents between the air and fuel intake and ignition. In other words, the engine carries out a three-stage combustion cycle rather than a four-stage combustion cycle. However, this arrangement of circular rotors and stators allows the number of combustion chambers per rotor to be increased beyond that of prior art rotary combustion engines, thereby increasing the number of combustion cycles carried out during rotation of the driveshaft.

Preferably the cavities extend into the rotor from a periphery thereof.

Preferably each cavity is asymmetric about a radius of the rotor.

Preferably the cavities are not radial with respect to the central axis.

Preferably the cavities are angled with respect to a radius of the rotor to dispose an inner end of each cavity forward of an outer end thereof in the predetermined direction of rotor and driveshaft rotation. In this instance, the cavities are preferably angled from the radius by about forty-five degrees.

Preferably the air and fuel intake comprise separate air and fuel intakes angularly spaced about the central axis.

Preferably the fuel intake comprises a fuel injector.

The spark plug may be supported on a peripheral wall of the stator to provide sparks at a point radially outward from an inner surface of the peripheral wall.

Preferably there is provided a pressure boosting component connected to the air and fuel intake to increase pressure of the air fed to the engine.

Preferably the pressure boosting component comprises a turbocharger connected between the air and fuel intake and the exhaust outtake.

The at least one rotary combustion unit may comprise a plurality of rotary combustion units arranged end to end and the drive shaft passing through each stator is a common drive shaft passing through all of the rotary combustion units for driven rotation thereby.

Angular spacing of the air and fuel intake, spark plug and exhaust outtake about the common driveshaft may be equal in each stator. In this instance, preferably angular positions of the air and fuel intake, spark plug and exhaust outtake of adjacent rotary combustion units about the common driveshaft are offset.

Preferably angular positions of the spark plugs of adjacent rotary combustion units about the common driveshaft are offset.

The angular positions of the spark plugs of the plurality of rotary combustion units about the common driveshaft may lie on a spiral path thereabout.

The plurality of cavities in each rotor may comprise at least five cavities.

Angular spacing between adjacent ones of the plurality of cavities about the central axis may be equal.

Two of the plurality of cavities may be spaced apart about the central axis by the same angle as the spark plug and exhaust outtake. These two of the plurality of cavities may be adjacent one another about the central axis.

The air and fuel intake, the spark plug and the exhaust outtake may be respectively positioned at an intake quadrant, an ignition quadrant and an exhaust quadrant of the stator interior.

The exhaust quadrant and ignition quadrant may be adjacent the intake quadrant at opposite ends thereof, leaving a fourth quadrant between the ignition and exhaust quadrants, and the combustion stage may be substantially completed during rotation of the rotor through the ignition and fourth quadrants.

The plurality of cavities may include between two and eight cavities.

### BRIEF DESCRIPTION OF THE DRAWINGS

In the accompanying drawings, which illustrate a exemplary embodiments of the present invention:

FIG. 1 is an end view of a rotary combustion unit according to a first embodiment with a housing of the unit cut away.

FIG. 2 is a side view of the rotary combustion unit of FIG. 1 with the housing cut away.

FIG. 3 is a partial perspective view of a rotor of the rotary combustion unit of FIG. 1.

FIG. 4 is an end view of a rotary combustion unit according to a second embodiment with a housing of the unit cut away.

FIG. 5 is a side view of the rotary combustion unit of FIG. 4 with the housing cut away.

FIG. 6 is a partial perspective view of a rotor of the rotary combustion unit of FIG. 4.

FIG. 7 is a side view of an internal combustion engine featuring a plurality of rotary combustion units according to the present invention.

FIG. 8 is an end view of the engine of FIG. 7.

FIG. 9 is an end view of the rotor of FIG. 1.

FIG. 10 is a side view of the rotor, housing, fuel injector and spark plug of the rotary combustion unit of FIG. 1 with the housing cut away.

FIG. 11 is the view of FIG. 10 with the rotor removed to illustrate the stages of the combustion cycle experienced during rotation of the rotor inside the housing.

### DETAILED DESCRIPTION

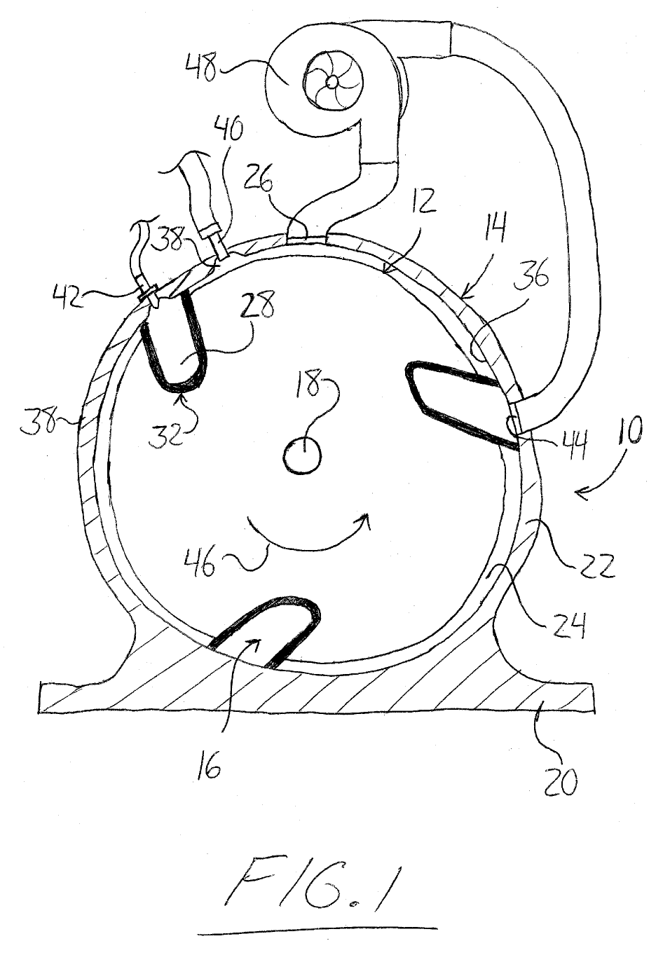

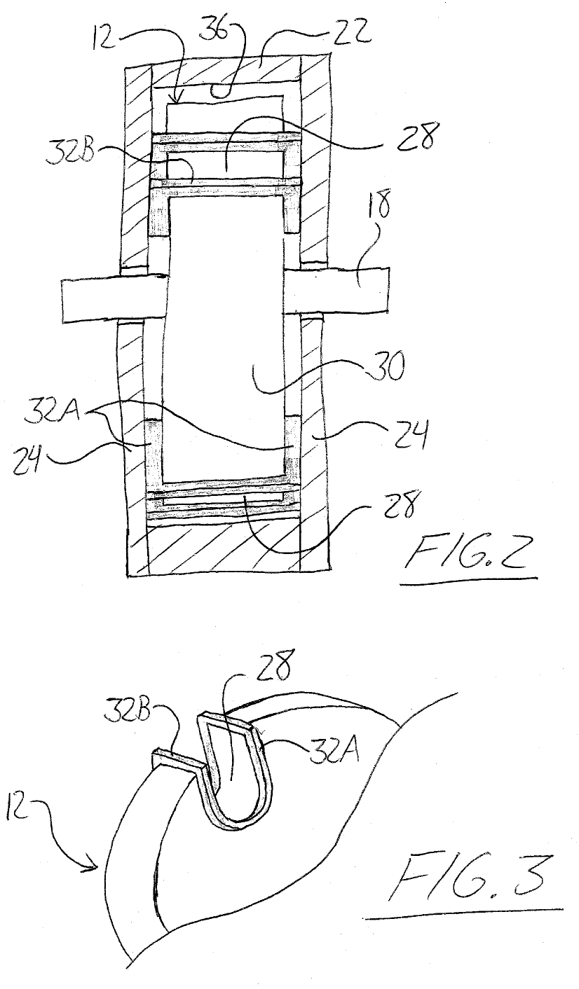

FIG. 1 shows a single combustion unit 10 of a rotary internal combustion engine according to a first embodiment of the present invention. The combustion unit differs from those of prior art rotary engines in that the rotor 12 and the interior of the stator, or rotor housing, 14 are both circular. This allows the number of combustion chambers 16 defined between the rotor 12 and stator 14 can be increased to complete more stages of the combustion cycle per rotation of the driveshaft 18. In the prior art, the difference in shape between the rotor and stator was used to alter the size of the combustion chambers during rotation of the rotor to provide compression of the air and fuel mixture prior to ignition. From the following description, it will be appreciated that the engine of the present invention runs on a three-stage cycle that does not involve compression of the fuel and air mixture between the intake and combustion stages.

In the first embodiment, the stator 14 features a rectangular base 20 on which is supported an annular peripheral wall 22 which cooperates with ends walls 24 to enclose a hollow cylindrical interior of circular cross section. The rotor 12 is a cylinder of round cross section supported about driveshaft 18 concentrically within the stator interior. The rotor 12 and driveshaft 18 are connected for rotation together about a central axis of the stator interior. An air intake port 26 extends through the peripheral wall 22 of the stator to feed air into cavities 28 extending into the rotor 12 from a periphery 30 thereof. Each cavity 28 is provided with a seal 32 extending from the rotor 12 to the stator walls 14, 24 about the cavity to define a combustion chamber 16 formed in part by the cavity. In other words, space between the rotor and stator at each cavity is enclosed to form a sealed combustion chamber. In the first embodiment, each cavity 28 extends fully through the rotor 12 parallel to the drive shaft 18. As a result, each seal 32 features face portions 32A projecting from the end faces 34 of the rotor 12 to seal against the respective end walls 24 of the stator, and peripheral portions 32B projecting from the rotor periphery 30 along opposite edges of the cavity to seal against the inner surface 36 of the stator's peripheral wall 22.

Spaced along the stator periphery wall 22 from the air intake, a fuel intake port 38 extends through the peripheral wall 22 of the stator. A fuel injector 40 extends into the port 38, but not past the interior surface 36 of the rotor periphery wall 22, to add fuel to the air provided in the cavities 28 by the air intake 26. Spaced farther along the stator periphery wall 22 is a spark plug 42, also extending into the periphery wall from an exterior of the stator but not past the interior surface 36 thereof. Spaced even farther along the stator periphery wall 22 is an exhaust outtake port through which exhaust gases from the combustion chamber 16 are discharged from the stator interior.

From the above, it will be appreciated that the combustion unit 10 operates in a similar manner to prior art rotary combustion engines in that rotation of the rotor 12 acts to move the combustion chambers 16 about the drive shaft 18 along the inner surface 36 of the stator periphery wall 22. As each cavity passes the air intake port 26, air enters the region enclosed by seal 32. Rotation continues passed the fuel injector 40 from which fuel is sprayed into the air-filled combustion chamber 16 such that when the chamber reaches the spark plug 42, a spark discharged therefrom ignites the mixture of air and fuel to cause combustion. The sudden pressure increase of the resulting explosion pushes against the walls of the cavity such that rotation of the rotor 12 continues, moving the combustion chamber toward the exhaust outtake port 44. As the cavity 28 passes the outtake, the expansion of the gases from combustion causes them to exit the sealed cavity through the port. Rotation of the rotor 12 continues under inertia to return the cavity 28 to the air intake port 26 where the combustion cycle begins again.

As seen in the Figures, the cavities 28 are neither symmetric about nor aligned with the radius of the rotor 12 at their respective angular positions about the driveshaft 18. The cavities 28 are angled toward the direction of rotation, indicated by arrow 46, from the radius at the opening of the cavity in order to promote rotation of the rotor 12 in a predetermined direction corresponding to the order in which the intake, combustion and outtake elements are disposed about the stator under the forces exerted by combustion of the fuel.

The figures show three cavities 28 spaced equally about the rotor 12, but it should be appreciated that this number and spacing may be varied and that increasing the number of combustion chambers increases the number of combustion cycles completed per rotation of the driveshaft 18, as each cavity passes fully about the drive shaft 18 per rotation thereof. As a result, the combustion unit should be capable of providing a significant amount of power. It is conceptualized that the rotor could be provided with anywhere from two to eight cavities, but should not be limited to this range. A rotor with only two cavities will carry the combustion chambers through six stages in one revolution of the driveshaft, corresponding to the number of stages completed in two full three-stage combustion cycles. A rotor with five cavities will carry the combustion chambers through 15 stages in one revolution of the driveshaft, corresponding to the number of stages completed in five full three-stage combustion cycles. In comparison, the piston of four stroke reciprocating engine completes one-half of a four-stage combustion cycle per crankshaft revolution; the piston of a two stroke reciprocating engine completes one four-stage combustion cycle per crankshaft revolution; the rotor of a Wankel engine carries out four stages per driveshaft revolution, corresponding to the number of stages completed in one full four-stage combustion cycle; and the quasiturbine engine carries out 16 stages per driveshaft revolution, corresponding to the number of stages completed in four full four-stage combustion cycles.

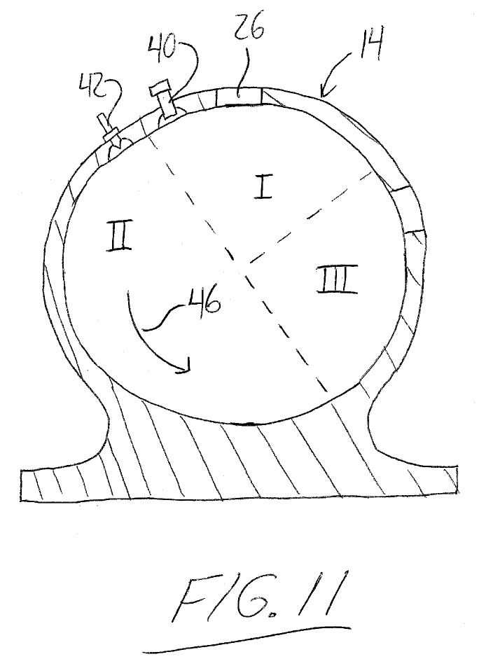

FIGS. 9 and 10 show details regarding the positioning of components in the illustrated embodiments. The longitudinal axis A of each cavity 28 extending into the rotor 12 from the periphery intersects with the radius R of the rotor at the center of the cavity opening at a predetermined angle α to dispose an inner closed end of the cavity ahead of the cavity opening in the rotor periphery 30 in the direction of the rotor's rotation. As a result, the resultant force exerted on the rotor by the expansion of gas after ignition does not occur along the rotor radius R and therefore acts to drive rotation of the rotor about the driveshaft's central axis. The orientation of each cavity 28 at each of the intake, ignition or outtake elements during the rotors rotation depends on the angle α of the cavity relative to the rotor radius R and the angular position of the particular stationary element on the stator 12 about the central axis. For example, in FIG. 10, the angle β of the spark plug 42 relative to vertical V about the central axis in the direction of rotation 46 is approximately forty-five degrees, which when combined with the angle α of approximately forty-five degrees of the cavity 28 relative to the rotor radius R results in the cavity extending vertically downward beneath the spark plug. In the illustrated embodiments, the inter-cavity angular spacing θ is equal to the angular spacing φ between the spark plug 42 and exhaust outtake port 44 so that, during rotation of the rotor 12, as the combustion cycle is completed in one cavity, it begins in another.

FIG. 11 shows the stator interior divided into sections I, II and III each corresponding to a stage of the combustion cycle carried out therein. Section I contains the air intake port 26 and the fuel injector 40. Section II contains the spark plug and section three contains the exhaust outtake port 44. As shown, the sections may be approximated using quadrants, in which case section I and III are each a single quadrant while section II is made up of two adjacent quadrants disposed between sections I and III in the direction of rotor rotation 46. As the rotor begins to spin, for example under the action of a starter, a first cavity receives a charge of air from the air intake port 26 as it moves therepast and continues on to the fuel injector 40 where fuel is added to the charge of air. The rotor continues spinning, carrying the first cavity into section II where the spark plug provides a spark that ignites the fuel. Contained within a combustion chamber formed by the rotor, stator and seal therebetween, the combusting fuel creates an increase in pressure which acts upon the cavity surfaces to force further rotation of the rotor. As the first cavity passes through the quadrants of section II, a second cavity passes through section I, first receiving air and then fuel. Before the first cavity reaches section III, the second cavity has begun combustion under the ignition provided by the spark plug 42 upon entry to section II, powering further rotation of the rotor and connected drive-shaft. As the second cavity continues passing through section II, the third cavity passes through section I, receiving air and fuel. With the exhaust outtake port 44 and spark plug 42 spaced apart by the same angular distance as the cavities 28, as the first cavity reaches the exhaust port, the third cavity reaches the spark plug 42 for ignition. Discharging its contents through the exhaust outtake port, the first cavity continues into the section I to repeat the process. In this one revolution of the rotor and connected driveshaft, each cavity has passed through each of the three sections. Thus, in subsequent revolutions, each cavity will undergo the three stages of the combustion process; the intake stage (section I), the combustion or power stage (section II) and the exhaust stage (section III).

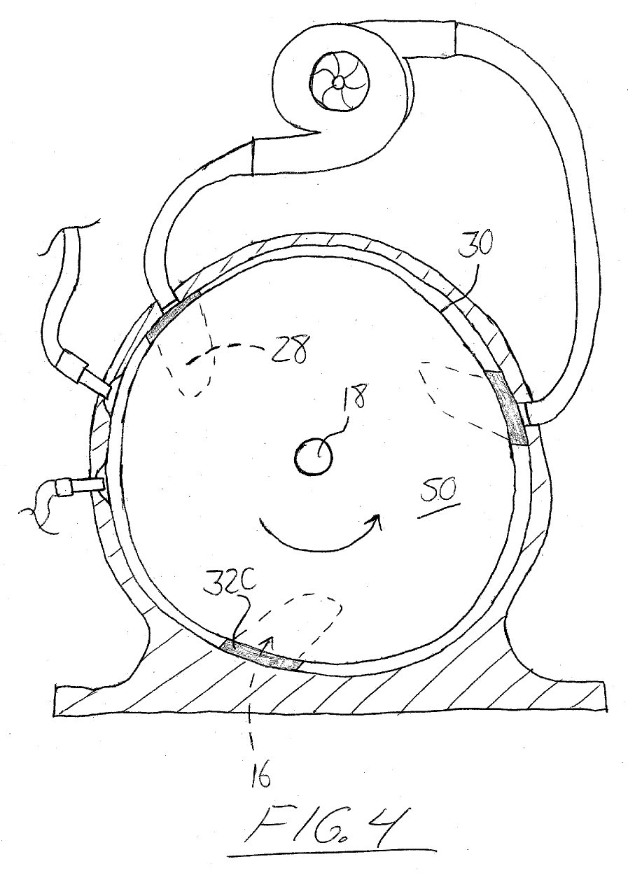

As there is no compression stage provided during rotation of the rotor 12 between the intake stage (at air intake port 26 and fuel injector 40) and combustion stage (beginning at spark plug 42), it may be desirable to try and increase the pressure of incoming air entering through the air intake port 26. As shown in FIGS. 1 and 4, a turbocharger 48 or supercharger may be connected to compress air entering the unit. A turbocharger uses the flow of exhaust gases from the exhaust outtake 44 to drive a compressor to increase the pressure of air fed into the combustion unit through the air intake port 26. A supercharger provides the same function but obtains its input energy from rotation of the drive shaft rather than the flow of exhaust gases. Use of these components is well known to those of skill in the art.

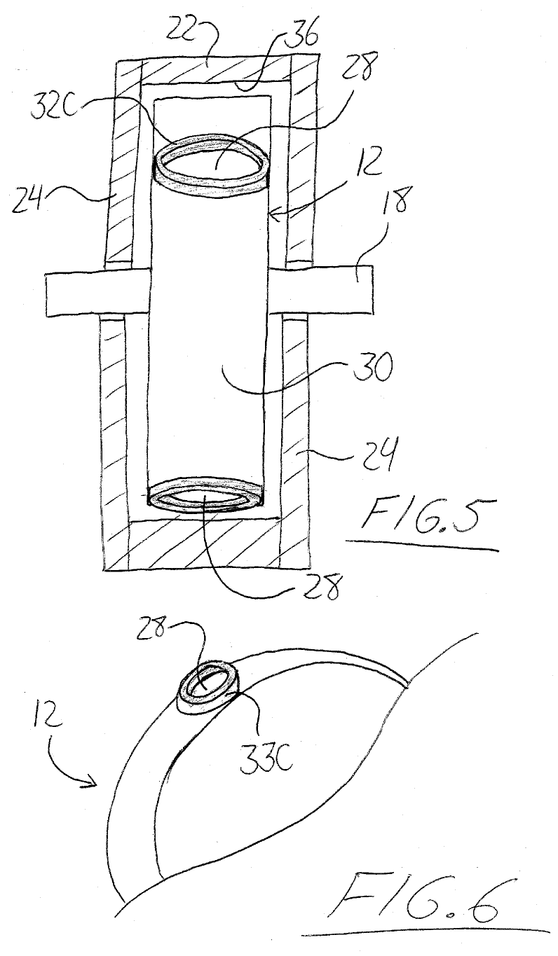

FIGS. 4 to 6 show a rotary combustion unit of a second embodiment of the present invention which differs from that of the first embodiment in that the cavities 28 do not extend fully through the rotor 12, but rather extend thereinto from the periphery 30 leaving each end face 50 of the rotor intact. As a result, the seal 33C about the cavity is disposed entirely on the periphery 30 of the rotor 12, protruding outward therefrom around the entire opening of the cavity to seal against the inner surface 36 of the stator's periphery wall 22. In this embodiment, the end faces 24 of the stator to not help define the combustion chambers 16, as they are enclosed entirely by the rotor 12, seal 33C and periphery wall 22 of the stator.

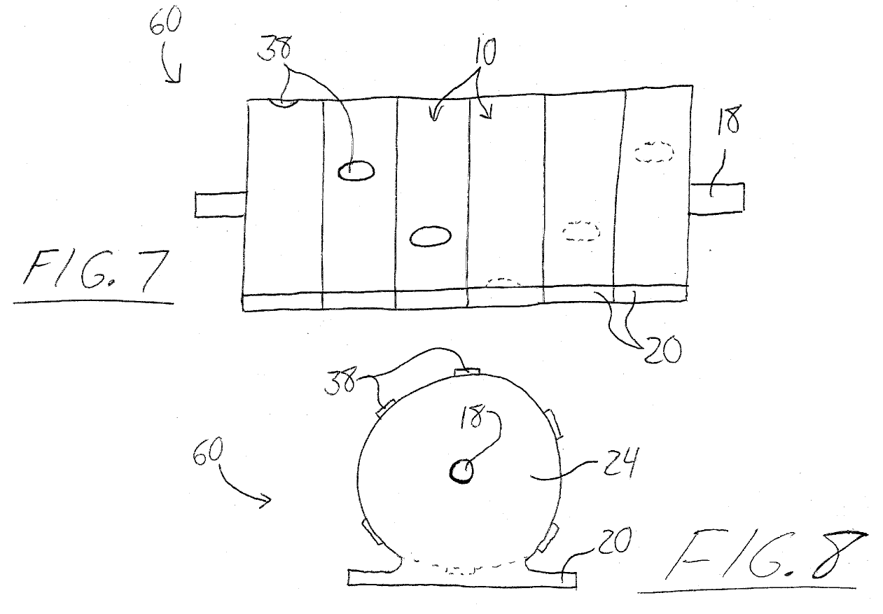

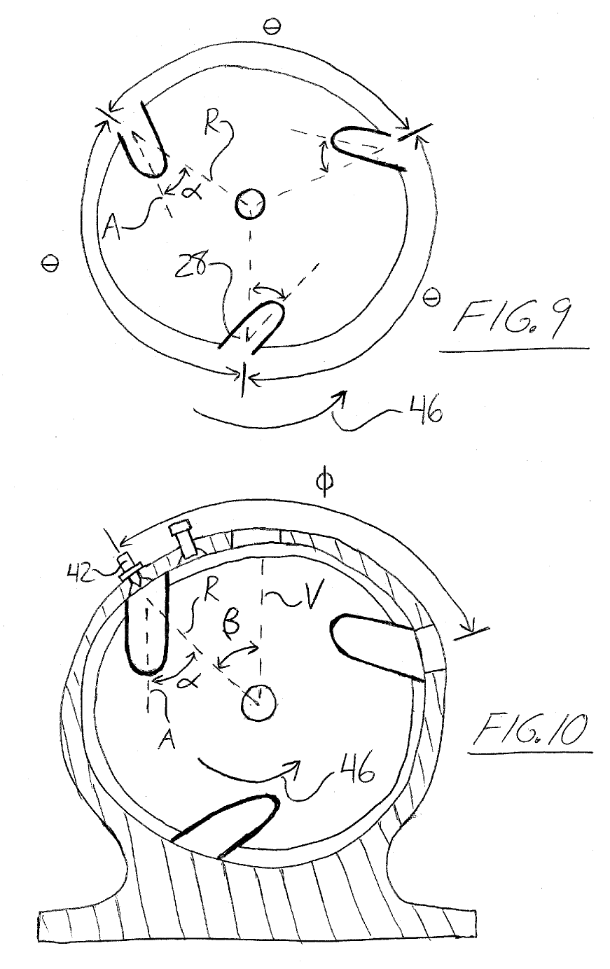

FIGS. 7 and 8 show an engine 60 made up of a plurality of rotary combustion units 10 of the present invention. The units are arranged face to face (i.e. end wall 24 to end wall 24) with a common drive shaft 18 extending through the group of units for powered rotation thereby. Although it should be appreciated that the angular spacing of the intakes, spark plug and outtake may be modified from that shown in FIGS. 1 and 4, if each of the units 10 in FIGS. 7 and 8 are considered to have the same angular positioning of these components thereabout, then it should be appreciated that the staggering of the intake ports 38 acts to change the angular regions about the driveshaft in which combustion occurs from one unit to the next. Should the rotors 12 of the units 10 each have the same number of cavities 28 and be mounted to the driveshaft to align the cavities of the rotors about the driveshaft, then the staggering of the equally spaced intake, outtake and ignition components from one unit to the next can also be used to sequence combustion between the units. Similarly, staggering the angular positions of the cavities of the units about the driveshaft from one unit to the next will also affect combustion sequencing.

It should be appreciated that although the illustrated embodiments are shown as having direct fuel injection in which the air and fuel intakes are separate, a number of different possible intake systems known to those of skill in the art may be used with the present invention. For example, in a multi-unit engine like that of FIGS. 7 and 8, fuel could be injected into an intake manifold upstream from the air intake port either before or after division of the air intake stream for delivery to the different combustion units. As another example, a carburetor could be used to control the addition of fuel to the air intake stream for delivery through an intake manifold to the combustion units.

Although the air and fuel intakes, the spark plug and the exhaust outtake are each illustrated as accessing the stator interior through the peripheral wall 22, it should be appreciated that these elements may be provided at an end wall 24 of stator instead for embodiments where the cavities are open at one or both of the rotor end faces 50, regardless of whether the cavities also open to the rotor periphery. The intake, outtake and ignition elements would be provided in the end wall(s) 24 radially outward from the driveshaft 18 and angularly spaced thereabout. A recess from the inner face of the end wall to which the spark plug is mounted would similarly be provided to position the spark plug outward from the otherwise cylindrical hollow interior of the stator defined by the inner surfaces of the annular wall and end walls so as not to interfere with rotation of the rotor. Of course, such an arrangement could not apply to the second embodiment shown in FIGS. 4 to 6 wherein the cavities are only open at the periphery 30 of the rotor 12, as access to the combustion chambers from the end walls 24 of the stator is blocked by the end faces 50 of the rotor 12. While the cavities are illustrated as having an elongate shape extending inward from the periphery of the rotor, it should be appreciated that the illustrated shape, orientation and spacing of the cavities may be varied in the present invention, for example to increase surface area of the rotor-defined wall(s) of the combustion chamber at the leading end thereof in the driving rotational direction, to increase the rotation-inducing force exerted by the application of pressure at this leading end after ignition of the air and fuel mixture.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An internal combustion engine comprising
at least one rotary combustion unit comprising:
a stationary stator defining a cylindrical interior of circular cross section;
a cylindrical rotor of circular cross section supported within the stator interior for rotation with a drive shaft extending through the stator along a central axis, the rotor having a plurality of cavities therein radially spaced from the drive shaft and angularly spaced thereabout;
each cavity in the rotor having a respective seal disposed thereabout extending outward from the rotor to the stator;
an air and fuel intake extending from an exterior of the stator to an interior thereof to feed fuel and air into the engine for combustion therein;
a spark plug supported on the stator to provide sparks within combustion chambers, each combustion chamber formed by enclosure of a respective one of the cavities in the rotor by the stator and the respective seal during a combustion stage of the rotor's rotation; and
an exhaust outtake extending from the interior of the stator to the exterior thereof to discharge exhaust gases from the engine after combustion, the exhaust outtake being circumferentially spaced about the central axis from the air and fuel intake and spark plug;
whereby combustion of the fuel introduced to the cavities by the air and fuel intake due to ignition in the combustion chamber by the spark plug drives rotation of the rotor and drive shaft in a predetermined direction to pass the cavity through fluid communication with the exhaust outtake and once again reach the air and fuel intake to repeat the rotation.

2. The internal combustion engine according to claim 1 wherein the cavities extend into the rotor from a periphery thereof.

3. The internal combustion engine according to claim 1 wherein each cavity is asymmetric about a radius of the rotor.

4. The internal combustion engine according to claim 1 wherein the cavities are not radial with respect to the central axis.

5. The internal combustion engine according to claim 4 wherein the cavities are angled with respect to a radius of the rotor to dispose an inner end of each cavity forward of an outer end thereof in the predetermined direction of rotor and driveshaft rotation.

6. The internal combustion engine according to claim 1 wherein the air and fuel intake comprise separate air and fuel intakes angularly spaced about the central axis.

7. The internal combustion engine according to claim 1 wherein the spark plug is supported on a peripheral wall of the stator to provide sparks at a point radially outward from an inner surface of the peripheral wall.

8. The internal combustion engine according to claim 1 further comprising a pressure boosting component connected to the air and fuel intake to increase pressure of the air fed to the engine.

9. The internal combustion engine according to claim 1 wherein the at least one rotary combustion unit comprises a plurality of rotary combustion units arranged end to end and the drive shaft passing through each stator is a common drive shaft passing through all of the rotary combustion units for driven rotation thereby.

10. The internal combustion engine according to claim 9 wherein angular spacing of the air and fuel intake, spark plug and exhaust outtake about the common driveshaft is equal in each stator.

11. The internal combustion engine according to claim 10 wherein angular positions of the air and fuel intake, spark plug and exhaust outtake of adjacent rotary combustion units about the common driveshaft are offset.

12. The internal combustion engine according to claim 9 wherein angular positions of the spark plugs of adjacent rotary combustion units about the common driveshaft are offset.

13. The internal combustion engine according to claim 9 wherein the angular positions of the spark plugs of the plurality of rotary combustion units about the common driveshaft lie on a spiral path thereabout.

14. The internal combustion engine according to claim 1 wherein angular spacing between adjacent ones of the plurality of cavities about the central axis is equal.

15. The internal combustion engine according to claim 1 wherein two of the plurality of cavities are spaced apart about the central axis by the same angle as the spark plug and exhaust outtake.

16. The internal combustion engine according to claim 15 wherein the two of the plurality of cavities are adjacent one another about the central axis.

17. The internal combustion engine according to claim 1 wherein the air and fuel intake, the spark plug and the exhaust outtake are respectively positioned at an intake quadrant, an ignition quadrant and an exhaust quadrant of the stator interior.

18. The internal combustion engine according to claim 17 wherein the exhaust quadrant and ignition quadrant are adjacent the intake quadrant at opposite ends thereof, leaving a fourth quadrant between the ignition and exhaust quadrants, and the combustion stage is substantially completed during rotation of the rotor through the ignition and fourth quadrants.

19. The internal combustion engine according to claim 1 wherein the plurality of cavities includes between two and eight cavities.

20. The internal combustion engine according to claim 19 wherein the plurality of cavities includes three cavities.
